(19) United States
(12) Patent Application Publication
(10) Pub. No.: US 2004/0090940 A1
(43) Pub. Date: May 13, 2004

(54) Method of allocation for a broadcasting medium

(75) Inventor: Francois Paul, Le Plessis-Bouchard (FR)

Correspondence Address: LOWE HAUPTMAN GILMAN & BERNER, LLP, Suite 310, 1700 Diagonal Road, Alexandria, VA, 22314, US

(73) Assignee: THALES

(21) Appl. No.: 10/695,940

(22) Filed: Oct. 30, 2003

(30) Foreign Application Priority Data
Oct. 31, 2002 (FR) 02 13702

(51) Int. Cl. H04J 3/00; H04B 7/212

(52) U.S. Cl. 370/336; 370/347

(57) ABSTRACT

A method for the allocation of access to a broadcasting medium by several stations is disclosed. The method comprises encoding the identifier I of each of the stations, on a number n of bits b1, b2, . . . bn, using two symbols corresponding respectively to a reception state and to a transmission state. For any unspecified station Si, during an attempt to make transmission, starting at a given identification slot for i varying from 1 to n, if the value of bi is equal to the symbol corresponding to the reception state, the station Si receives during the slot k+i−1. If the station detects a signal sent by another station the station considers itself not to be chosen. If the station detects nothing, the station continues to scan the bits bi. If the value of bi is equal to the symbol corresponding to the transmission state, the station transmits during the slot k+i−1. The medium is allocated to the station that has performed without receiving the transmission symbol.

### BACKGROUND OF THE INVENTION

1. Field of the Invention

The invention relates especially to a method in which several stations are allocated access to a broadcasting network.

In the description, the term “broadcasting network” associates an environment in which several devices or stations are exchanging information or messages and in which different stations can receive messages. For example, the broadcasting environment may be radio and the stations may be radio transmitter/receiver (or transceiver) units.

2. Description of the Prior Art

The mechanisms currently used for the allocation of access by stations to a broadcasting medium, for example radio, are based either on a preliminary scheduling, such as that of the TDMA (Time Division Multiple Access) protocol or on a scheduling that is computed independently by each station accessing the medium, with the introduction of random components and feedback so as to reduce the effect of collision (examples are the “slotted Aloha” algorithm and the matching of probability of access).

Preliminary scheduling (TDMA) has the advantage wherein each station is guaranteed a minimum time of access to the network and a minimum proportion of use of the medium. However, it has the drawback of not adapting this allocation to the effective needs of each station, these needs being possibly variable in time. There may therefore be a disproportion between the performance that the broadcasting medium is capable of giving and the performance that is actually obtained.

The scheduling algorithms with matching, computed independently on each station, have the advantage of adapting to the effective use of the medium by the different stations. However, their specifications make systematic use of the deliberate introduction of random phenomena and of feedback mechanisms between the different stations. The state variables of the algorithms on a station vary as a function of the behavior of the other stations. Furthermore, these algorithms do not claim to eliminate collisions. They take them into account in their operations so as to reduce their frequency. All the stations that use such an algorithm therefore form a complex system for which it is practically impossible to demonstrate efficient operation in principle.

### SUMMARY OF THE INVENTION

An object of the present invention relates to a method used especially for the allocation of access to a broadcasting medium by at least two stations visible to each other.

The invention relates to a method for the allocation of access to a broadcasting medium by several stations, the method comprising at least the following steps:

a) encoding the identifier I of each of the stations, on a number n of bits b1, b2, . . . bn, using two symbols corresponding respectively to a “reception” state and to a “transmission” state,

b) For any unspecified station Si, during an attempt to make transmission, starting at a given identification slot,

b.1) for i varying from 1 to n,

b.1.1) if the value of bi is equal to the symbol corresponding to the “reception” state, the station Si receives during the slot k+i−1:

if it detects a signal sent by another station, it considers itself not to be chosen;

if it detects nothing, it continues to scan the bits bi

b.1.2) if the value of bi is equal to the symbol corresponding to the “transmission” state, the station transmits during the slot k+i−1;

c) allocating the medium to the station that has performed the step b.1) without receiving the transmission symbol.

It may comprise a step b.0) preliminary to the step b.1) for the sending of the “transmission” symbol by the station Si and the steps b.1), b.1.1), b.1.2) may be carried out on identification slots varying from k+1 to k+n.

The broadcasting medium is, for example, a radio network and the stations are transmitter-receiver stations.

The invention also relates to a system for the allocation of access to a broadcasting medium by several stations Si wherein the stations are provided with a digital processing circuit adapted to the execution of the steps of the method having one of the characteristics explained here above.

The method according to the invention has especially the following advantages:

It makes it possible to assign the broadcasting medium equitably between all the stations without causing collision, and in ensuring use of the medium at 100% or a closely as possible to 100%,

its implementation uses only the synchronization of all the stations on a common time base, and the preliminary assignment to each station of an identification in the form, for example, of an integer belonging to a predefined interval.

### BRIEF DESCRIPTION OF THE DRAWING

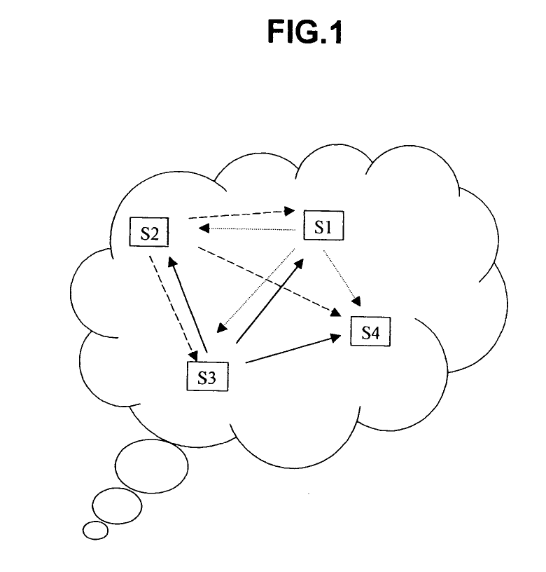

Other advantages and characteristics of the present invention shall appear more clearly from the following description with reference to the appended single FIG. 1 which is a drawing showing the architecture of several networking stations.

### MORE DETAILED DESCRIPTION

In order to provide for a clearer understanding of the method of the invention, the following description given by way of an illustration that in no way restricts the scope of the invention relates to a method of allocation of access by stations, for example radio transmitter/receiver units (or stations), to a radio network.

In brief, the principle of operation is the following: when several stations wish to access the radio network, they initiate an allocation sequence. During this sequence, all the stations Si simultaneously announce their identification, following a precise protocol that is the object of the invention. At the end of this allocation sequence, the station Se that has announced the greatest number is deemed have allocated the radio network to itself, i.e. it uses the network. The other stations Sj know that they are not chosen. Once the chosen station Se has finished using the radio network, the other stations repeat the steps of the method if they wish to allocate the radio network to themselves, i.e. if they wish to become the chosen station. So as not to favor any station, the identifications are routinely permutated.

FIG. 1 represents a radio network structure comprising several stations Si. The radio network is in a state of broadcasting: this is expressed by the fact that when a station Si transmits a signal containing a piece of information or a message, all the other stations know that a message or a piece of information has been sent.

The stations Si are adapted so that:

if several stations are transmitting simultaneously, then all the other stations are capable of determining the fact that at least one of the stations has sent out a piece of information, even if the contents of the information cannot be extracted (for example in the event of a scrambling of the information sent). For this purpose, the stations possess, for example, a computer programmed accordingly.

The stations Si have a common time base that divides the time into elementary intervals, for example equal intervals, hereinafter called “identification slots” referenced k. These identification slots are numbered from 0 with a reference known to all the stations. A periodic resetting of this reference at zero is possible. The duration of this periodic interval is set, for example, so as to preserve an equitable character for the algorithm implemented in the method according to the invention. The time base is, for example, provided by clocks with which each station is equipped. These clocks are synchronized with each other.

The method defines notably two types of elementary operations:

the “receive” operation: that is, for a station Si, detecting whether another station Sm is transmitting something, for example a message, during the slot k. If the station Si, when it is in a state of reception, detects a signal sent out by a station Sj, then it is said to receive the symbol “1”; if not it is said to receive the symbol “0”.

the “transmit 1” operation: the station Si transmits any signal during the slot k. The contents of the transmitted signal are not taken into account for the definition of this operation.

The method according to the invention comprises at least the following steps:

a) Assigning an Initial Identification to each Station Si.

This corresponds to assigning an identification number I₀ to a station, this identification number being encoded on a given number of bits n whose value is taken in a predefined interval of integers [0, N−1], such that N=2ⁿ. The initial identifications of the stations Si are different.

This assigning is done for example by a system of management and configuration external to the stations and known to those skilled in the art.

At each new time interval corresponding to an identification slot k, the current identification I of the station Si is computed by the station as a function of the initial value I⁰ and the current value of k. An exemplary method for the computation of I as a function of I₀ and k is given further below. This computation is made, for example, by means of a digital processing circuit, such as a processor or an ASIC, integrated into the station.

b) Attempt at Transmission

A station Si that wishes to have the radio network allocated to it (i.e. wishes to use the network) starts a sequence to announce its identification. At this time, its identification number has a given value I, written as follows in binary mode: b₁b₂ . . . bₙ₋₁bₙ. The announcing sequence comprises especially the following steps:

b.1 ) for i as a variant of 1 to n, i being the index of b,

b.1.1) if bi is equal to “0”, the station Si is in a state of reception during the slot k+i−1,

if the station receives the symbol “1”, it is not chosen. It aborts its allocation sequence (i.e. it makes an attempt to send) since the radio network will be allocated to another station Se. The station Si no longer transmits in the following slots, until the chosen station referenced Se has finished using the radio network.

If the station receives the symbol “0”, (state of reception), it continues the loop b.1).

b.1.2) If bi is equal to “1”, the station Si is in a transmission state; it transmits the symbol “1” during the slot k+i−1.

b.2) if the station has performed the steps of the loop b.1) without receiving the symbol [symbol] 1 [symbol] , then it is declared to be the chosen station Se.

c) At the end of the allocation sequence, the radio network is allocated to the station Se, while the other stations Sj wait for this chosen station Se to finish using the radio network. To this end, the stations of the network are equipped for example with a computer using a detection algorithm known, for example, to those skilled in the art.

According to one alternative embodiment, an additional step b0) is added before the step b1). This step b0) consists in transmitting during the slot k. The steps b1); b.1.1) and b.1.2) are performed during the slots k+1 to k+n, instead of the slots k to k+n−1.

So long as a station is in a state of reception, it can detect the starting of an allocation sequence initiated by one or more other stations because such a start takes the form of the transmission of a symbol “1”. Several stations may start an allocation sequence simultaneously, and the loop b2) serves to make a choice among them for assigning access to the medium.

Exemplary Method for Assigning the Current Identification I as a Function of the Initial Identification I⁰ and of the Current Value of k

This assigning is done, for example, as follows:

for any value of N, the algorithm (this is the algorithm for the computation of I as a function of I₀k) is given a piece of configuration data in the form, for example, of a permutation σ of the interval [0, n−1]. The permutation has only one cycle with the length N.

As mentioned earlier, a station is assigned an initial identification I₀ in an interval [0, N−1]. During the allocation sequence that starts at the slot k, the identification used is σ^{k}(I₀).

The value of σ is chosen in such a way that its successive iterations, applied to any initial subset of the interval [0, N−1], favor none of the initial elements.

An exemplary permutation on the interval [0, 31] is given in the following table 1 by way of an illustration:

| I | 0 | 1 | 2 | 3 | 4 | 5 | 6 | 7 | 8 | 9 | 10 | 11 | 12 | 13 | 14 | 15 | 16 | 17 | 18 |
|---|---|---|---|---|---|---|---|---|---|---|---|---|---|---|---|---|---|---|---|
| σ (i) | 14 | 27 | 4 | 19 | 28 | 30 | 16 | 5 | 17 | 24 | 2 | 25 | 18 | 23 | 31 | 21 | 8 | 3 | 0 |
| I | 19 | 20 | 21 | 22 | 23 | 24 | 25 | 26 | 27 | 28 | 29 | 30 | 31 | | | | | | |
| σ (i) | 26 | 11 | 10 | 6 | 12 | 29 | 13 | 9 | 22 | 20 | 15 | 1 | 7 | | | | | | |

Exemplary Implementation of the Method

The following example is given for a radio network with 4 stations present.

Let it be assumed that:

N=32

Four stations A, B, C and D are present in the radio network, their initial identifications are respectively 11, 12, 13 and 22.

The permutation σ chosen in the implementation is the one given in the table 1 as an example here above.

We consider only cases where the stations start allocation sequences simultaneously. For each station, the symbol “↑1” is used to indicate the operation “send 1” and the symbols “↓0” and “↓1” indicate the operations “receive 0” and “receive 1”.

Let us assume that an allocation sequence starts with the identification slot k=3827. k modulo 32=19, hence the iteration of the permutation is σ³⁸²⁷=σ¹⁹. The values of identification of the stations A, B, C and D are therefore respectively σ¹⁹(11)=3, σ¹⁹(12)=24, σ¹⁹(13)=26 and σ¹⁹(22)=25. The corresponding binary representations are A: 00011, B: 11000, C:11010 and D:11001.

Table 2 here below gives a bit-by-bit breakdown of the binary representation of the identification of the stations:

| | b1 | b2 | B3 | b4 | b5 |
|---|---|---|---|---|---|
| A | 0 | 0 | 0 | 1 | 1 |
| B | 1 | 1 | 0 | 0 | 0 |
| C | 1 | 1 | 0 | 1 | 0 |
| D | 1 | 1 | 0 | 0 | 1 |

The behavior of the stations will then be:

| Slot | K | k + 1 | k + 2 | k + 3 | k + 4 | k + 5 |
|---|---|---|---|---|---|---|
| A: | ↑1 | ↓1 | ↓1 | ↓0 | ↓1 | ↓0 |
| | | abort | | | | |
| B: | ↑1 | ↑1 | ↑1 | ↓0 | ↓1 | ↓0 |
| | | | | | abort | |
| C: | ↑1 | ↑1 | ↑1 | ↓0 | ↑1 | ↓0 |
| D: | ↑1 | ↑1 | ↑1 | ↓0 | ↓1 | ↓0 |
| | | | | | abort | |

The station C is chosen because it never receives the transmission symbol << 1 >>.

The steps of the method of access allocation described here above are used for example in the case of a radio network comprising several transmitter-receiver units provided with digital processing circuits, such as an ASIC programmed to execute the steps described here above or again a programmed processor.

The “activity” of a unit is detected, for example, by the detection of levels. For example, the operation “send 1” corresponds to the transmission of the noise. Thus, scrambling between the stations will not result in a diminishing of the level received.

The method according to the invention can also be applied to a local area network provided with computer devices such as microcomputers.

What is claimed is:

1. A method for the allocation of access to a broadcasting medium by several stations, the method comprising the following steps:
a) encoding the identifier I of each of the stations, on a number n of bits b1, b2, . . . bn, using two symbols corresponding respectively to a reception state and to a transmission state;
b) for any unspecified station Si, during an attempt to make transmission, starting at a given identification slot,
b.1) for i varying from 1 to n;
b.1.1) if the value of bi is equal to the symbol corresponding to the reception state, the station Si receives during the slot k+i−1:
if it detects a signal sent by another station it considers itself not to be chosen;
if it detects nothing, it continues to scan the bits bi;
b.1.2) if the value of bi is equal to the symbol corresponding to the transmission state, the station transmits during the slot k+i−1;
c) allocating the medium to the station that has performed the step b.1) without receiving the transmission symbol.

2. The method according to claim 1, comprising a step b.0) preliminary to the step b.1) for the transmission of the transmission symbol by the station Si and wherein the steps b.1), b.1.1), b.1.2) may be carried out on identification slots varying from k+1 to k+n.

3. The method according to claim 1, using binary encoding and the reception operation receive 1 when a station detects a signal coming from another station and receive 0 when it receives no signal and the send 1 operation when the station transmits a signal in a given slot.

4. The method according to claim 1 using an identification number taken in an interval [0, N−1] with N=2ⁿ.

5. The method according to claim 4 wherein the identification numbers are made to vary by the application of a permutation of the interval.

6. The method according to claim 1, wherein the broadcasting medium is a radio station and wherein the stations are transmitter-receiver units.

7. A method for the allocation of access to a broadcasting medium by several stations Si, wherein the stations are provided with a digital processing circuit adapted to execute the steps of a method comprising the following steps:
a) encoding the identifier I of each of the stations, on a number n of bits b1, b2, . . . bn, using two symbols corresponding respectively to a reception state and to a transmission state;
b) For any unspecified station Si, during an attempt to make transmission, starting at a given identification slot;
b.1) for i varying from 1 to n;
b.1.1) if the value of bi is equal to the symbol corresponding to the “reception” state, the station Si receives during the slot k+i−1:
if it detects a signal sent by another station it considers itself not to be chosen;
if it detects nothing, it continues to scan the bits bi
b.1.2) if the value of bi is equal to the symbol corresponding to the transmission state, the station transmits during the slot k+i−1;
c) allocating the medium to the station that has performed the step b.1) without receiving the transmission symbol.

8. The method according to claim 7, comprising a station configuration device that is separate from the stations.

9. The method according to claim 7, wherein the broadcasting medium is a radio station and wherein the stations are transmitter-receiver units.

10. The method according to claim 7, wherein the processing circuit is adapted to executing a step b.0) preliminary to the step b.1) for the transmission of the transmission symbol by the station Si and wherein the steps b.1), b.1.1), b.1.2) may be carried out on identification slots varying from k+1 to k+n.

11. The method according to claim 7, wherein the processing circuit is adapted to using binary encoding and the reception operation receive 1 when a station detects a signal coming from another station and receive 0 when it receives no signal and the send 1 operation when the station transmits a signal in a given slot.

12. The method according to claim 7, wherein the digital processing circuit is adapted to using an identification number taken in an interval [o, N−1] with N=2ⁿ.

13. The method according to claim 12, wherein the identification numbers are made to vary by the application of a permutation of the interval.
